(19) United States
(12) Patent Application Publication
(10) Pub. No.: US 2012/0154578 A1
(43) Pub. Date: Jun. 21, 2012

(54) DETECTOR FOR CHEMICAL AGENTS

(76) Inventor: Fariborz M. Bzorgi, Knoxville, TN (US)

(21) Appl. No.: 11/871,375

(22) Filed: Oct. 12, 2007

(51) Int. Cl. H04N 7/18; G08B 21/00

(52) U.S. Cl. 348/143; 340/603; 348/E07.085

(57) ABSTRACT

A chemical detection system for detecting chemicals entrained in a sample of ambient fluid. The ambient fluid may be atmospheric air, a process gas, or a liquid such as water. Some embodiments employ a plurality of chemical detection sensors and in some embodiments one or more of the chemical detection sensors have two levels of alarm conditions. A situation indicator is provided to provide alarm indications when the concentration level of chemicals exceeds a threshold amount. In some embodiments the chemical detection system includes a collection device for retaining a sample of chemicals entrained in ambient fluid. A visual imaging device may be provided to produce an electronic visual image of a scene associated with a location of the chemical detection system. Visual image data and detected chemical concentration levels may be recorded in an information storage system.

### GOVERNMENT RIGHTS

The U.S. Government has rights to this invention pursuant to contract number DE-ACO5-000R22800 between the U.S. Department of Energy and BWXT Y-12, L.L.C.

### FIELD

This disclosure relates to the field of detectors for chemical agents. More particularly, this disclosure relates to portable, hand-held detectors for chemical agents.

### BACKGROUND

Law enforcement officers, military anti-chemical-warfare personnel, other protective and investigative authorities, and safety and industrial engineers are often confronted with dangerous environments where chemical agents have been dispersed either accidentally, deliberately or incidentally as a byproduct of a chemical process. In order to effectively evaluate the potential source and the potential effects of such chemical releases it is first necessary to be alerted to their presence and then to be able to identify what they are. Often these chemical agents are toxic, and quick detection of their presence is needed in order to avoid injury to or death of persons who come into contact with them. Unfortunately, these encounters typically occur in the field, often unexpectedly and generally at locations far from laboratory analytical instruments. Most existing portable sensors are complicated and difficult for the typical enforcement official to operate. What are needed therefore are field-portable instruments that are easy to operate and provide quick analysis of potential chemical hazards.

### SUMMARY

In one embodiment the present disclosure provides a chemical detection system that has a plurality of chemical detection sensors. Each sensor is configured to detect a concentration level of a different chemical. The system also has an ambient fluid sampling system that is configured to provide at least a portion of a processed ambient fluid to the plurality of chemical detection sensors. There is an evaluation system that is configured to associate an alarm threshold level with each of the plurality of chemical detection sensors and configured to provide an alarm indication if the concentration level of the chemical detected by each of the plurality of the chemical detection sensors in the at least a portion of the processed ambient fluid exceeds the alarm threshold level of that chemical detection sensor.

Another embodiment provides a chemical detection system that has a chemical detection sensor that is configured to detect a concentration level of a chemical. There is an ambient fluid sampling system that is configured to provide at least a portion of a processed ambient fluid to the chemical detection sensor. There is an evaluation system that is configured to associate an alarm threshold level with the chemical detection sensor and configured to associate a dangerous threshold level with the chemical detection sensor and configured to provide an alarm signal if the concentration level of the chemical detected by the chemical detection sensor in the at least a portion of the processed ambient fluid exceeds the alarm threshold level of the chemical detection sensor. The evaluation system is further configured to provide an urgent alarm signal if the concentration level of the chemical detected exceeds the dangerous threshold level of the chemical detection sensor.

Another embodiment provides a chemical detection system that includes a chemical detection sensor that is configured to detect a concentration level of a chemical. There is also an ambient fluid sampling system that is configured to provide at least a portion of a processed ambient fluid to the chemical detection sensor. An evaluation system is provided, the evaluation system being configured to associate an alarm threshold level with the chemical detection sensor and configured to provide an alarm signal if the concentration level of the chemical detected by the chemical detection sensor exceeds the alarm threshold level of the chemical detection sensor. Further there is a sample collection device that is configured to retain a sample of chemicals from the processed ambient fluid.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a somewhat schematic perspective illustration of a first embodiment of a chemical detection system.

FIG. 2 is a somewhat schematic illustration of a visual image displayed on a situation indicator.

FIG. 3 is a somewhat schematic illustration of a chemical detector sensor cartridge.

FIG. 4 is a somewhat schematic top view of a second embodiment of a chemical detection system.

FIG. 5 is a somewhat schematic elevation view of the second embodiment of a chemical detection system depicted in FIG. 4.

FIG. 6 is a somewhat schematic elevation view of a third embodiment of a chemical detection system.

### DETAILED DESCRIPTION

In the following detailed description of the preferred embodiments, reference is made to the accompanying drawings, which form a part hereof, and within which are shown by way of illustration the practice of specific embodiments of chemical detection systems. It is to be understood that other embodiments may be utilized, and that structural changes may be made and processes may vary in other embodiments.

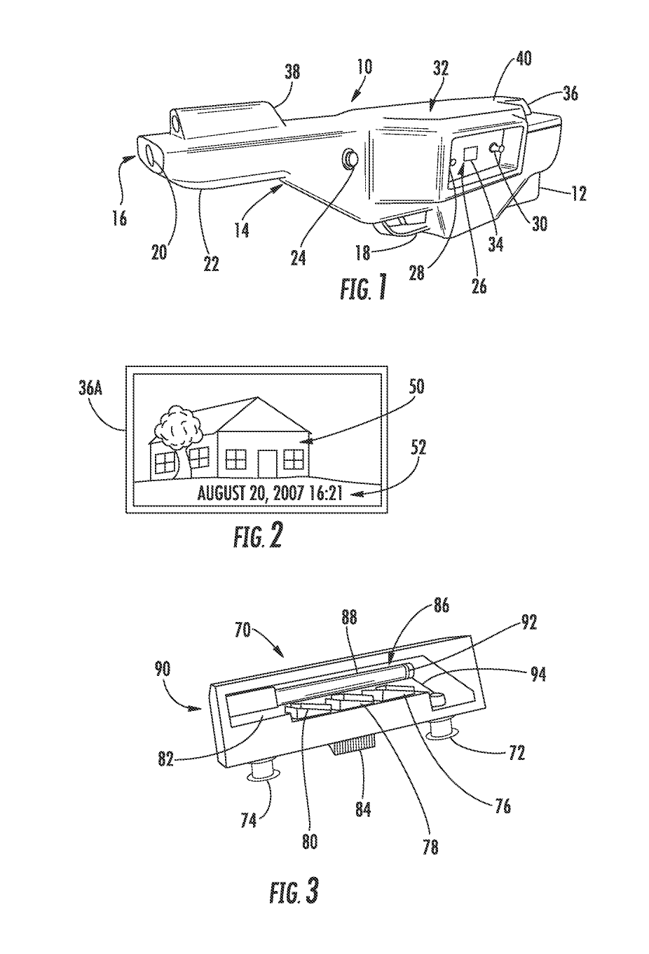

FIG. 1 illustrates one embodiment of a chemical detection system 10. In the embodiment of FIG. 1 the chemical detection system 10 is a hand-held portable device powered by a battery 12. The chemical detection system 10 has an aspirator 14 that is configured to draw in a sample of an ambient fluid from the environment through a detection port 16 when a trigger 18 is depressed. Typically the ambient fluid is air from the atmosphere outdoors or air in a building. However in some embodiments the ambient fluid may be a gas from a process gas system. In some embodiments the ambient fluid may be a liquid, such as water from a lake or stream.

In some embodiments the detection port 16 is the end of a tube 20. In some embodiments the tube 20 is approximately six inches long and in some embodiments the tube 20 is approximately six to twelve inches long and in some embodiments the tube 20 is approximately six to twenty-four inches long. Typically a stock 22 of the chemical detection system 10 is configured so that the tube 20 may be substantially fully retracted into the stock 22 for storage. In some embodiments the tube 20 may have a telescoping configuration wherein the tube 20 has a shortened configuration when retracted into the stock 22 and the tube 20 has a lengthened configuration when protracted from the stock 22 for use. In some embodiments the tube 20 may be protracted by pressing a button 24 that is configured with a spring release or similar mechanism to extend the detection port 16 of tube 20 beyond the stock 22.

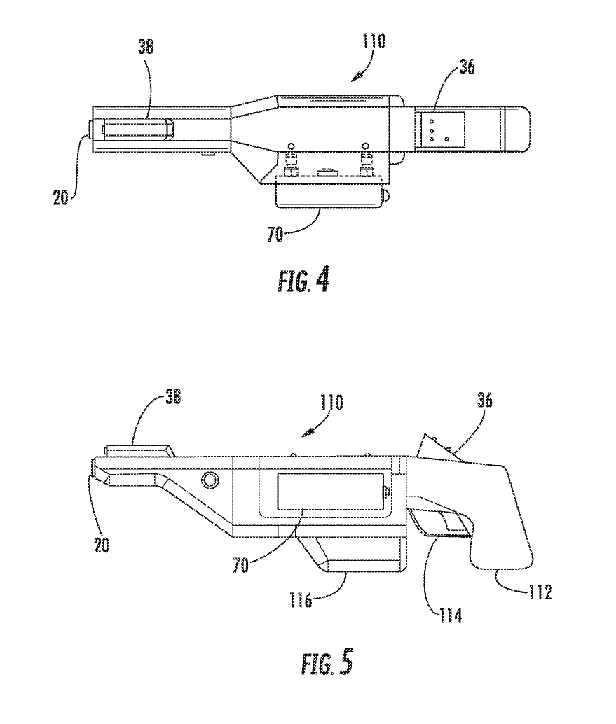

In the embodiment of FIG. 1, the chemical detection system 10 includes a chemical detector bay 26 for installation of a chemical detector sensor cartridge (70 in FIG. 3). The chemical detector bay 26 includes a fluid entry port 28 and a fluid exit port 30. At least a portion of the ambient fluid drawn in by the aspirator 14 is conveyed to the fluid entry port 28 into the chemical detector sensor cartridge 70 where it is processed by the chemical detector sensor cartridge 70. Substantially all of the ambient fluid that is conveyed to the fluid entry port 28 and into the chemical detector sensor cartridge 70 by the aspirator 14 is removed from the chemical detector sensor cartridge 70 though fluid exit port 30 and is exhausted to the ambient environment. The flow of ambient fluid into the chemical detector sensor cartridge 70 may be induced by a positive pressure produced by the aspirator 14 at the fluid entry port 28, or the flow of ambient fluid into the chemical detector sensor cartridge 70 may be induced by a negative pressure produced by the aspirator 14 at the fluid exit port 30 (which causes ambient fluid to be drawn into the chemical detector sensor cartridge 70 through the fluid entry port 28), or the flow of ambient fluid into the chemical detector sensor cartridge 70 may be induced by a combination of positive pressure at the fluid entry port 28 and negative pressure at the fluid exit port 30. In some embodiments, depending primarily upon the location of the aspirator 14 within the chemical detection system 10, the location of the fluid entry port 28 and the fluid exit port 30 depicted in FIG. 1 may be reversed.

The combination of the detection port 16, the aspirator 14, the fluid entry port 28, the chemical detector bay 26, and the fluid exit port 30 is an example of an ambient fluid sampling system. It should be appreciated that alternate embodiments with different configurations of an ambient fluid sampling system may be employed to provide samples of ambient fluid to a chemical detector sensor cartridge (e.g., the chemical detector sensor cartridge 70).

An electronics module 32 is in operable communication with the chemical detector sensor cartridge 70 through an electronic input/output connector 34. It shall be understood that the term “in operable communication with” refers to direct or indirect communication of suitable signals between two elements (e.g., the electronics module 32 and the chemical detector sensor cartridge 70) either directly or indirectly through one or more intermediate elements (e.g., the electronic input/output connector 34).

The chemical detection system 10 also typically includes a situation indicator 36. In some embodiments the situation indicator 36 may be a single on/off indicator, such as a light emitting diode. In alternate embodiments the situation indicator 36 may be a plurality of on/off indicators. In some embodiments the situation indicator 36 may be an alpha-numeric display. In some embodiments the display may be a graphical display that is capable of displaying graphical shapes or single frame images or video images. In some embodiments the situation indicator 36 includes a speaker and/or an earphone jack to provide an audible indication to the operator of the chemical detection system 10. In some embodiments the situation indicator 36 includes a mechanical vibrator to provide a vibratory indication.

Continuing with FIG. 1, a visual imaging device 38 may be provided with the chemical detection system 10. The visual imaging device 38 may be a still camera or a video camera, and the camera may be a visible image camera or an infrared camera or a specialized camera such as a night-vision camera. If so-configured, as illustrated in FIG. 2, the visual imaging device 38 may produce a visual image 50 of a scene associated with a location of the chemical detection system 10 at an image reference time 52, which includes the data and time when the image was produced. FIG. 2 illustrates that at the image reference time 52 when the visual image 50 was produced, the chemical detection system 10 was at a location near a tree and a building. The visual image 50 and/or the image reference time 52 may be displayed on a video display such as the situation indicator 36A illustrated in FIG. 2. In some embodiments the visual image 50 and optionally the image reference time 52 may be transmitted (preferably wirelessly) to a remote location by the visual imaging device 38.

In some embodiments the electronics module 32 may be configured to receive the visual image 50 from the visual imaging device 38 for transmission to a remote location. In such embodiments the image reference time 52 may be generated by the visual imaging device 38 or generated by the electronics module 32, and the visual image 50 and optionally the image reference time 52 may be transmitted (preferably wirelessly) by the electronics module 32 to the remote location. The electronics module 32 may include an information storage system 40, and the electronics module 32 may be configured to record the visual image 50 and optionally record the image reference time 52 in the information storage system 40. The information storage system 40 is typically a removable electronic medium that may be taken out of the chemical detection system 10 and retained for future analysis or evidentiary purposes.

FIG. 3 illustrates further details of the previously-mentioned chemical detector sensor cartridge 70. In the embodiment of FIG. 3, the chemical detector sensor cartridge 70 includes a fluid entry coupler 72 for receiving a flow of ambient fluid from the fluid entry port 28 of the chemical detector bay 26 and a fluid exit coupler 74 for exhausting ambient fluid to the fluid exit port 30 of the chemical detector bay 26. The ambient fluid that flows through the chemical detector sensor cartridge 70 is referred to herein as “processed ambient fluid.” The chemical detector sensor cartridge 70 includes three chemical detection sensors 76, 78 and 80 disposed in a detection chamber 82 of the chemical detector sensor cartridge 70. In some embodiments only one chemical detection sensor may be used, and in some embodiments more than three chemical detection sensors may be used. The detection chamber 82 is configured so that at least a portion of the ambient fluid that flows into the detection chamber 82 through the fluid entry coupler 72 flows over the array of chemical detection sensors 76, 78 and 80 and out of the detection chamber 82 through the fluid exit coupler 74.

Each of the chemical detection sensors 76, 78, and 80 is typically configured to detect a specific chemical where the specific chemical detected by each chemical detection sensor (e.g., 76) is different from the specific chemical detected by the other chemical detection sensors (e.g., 78 and 80). Each of the chemical detection sensors 76, 78, and 80 is also configured to provide an electronic signal indicative of the concentration level of its specific chemical. The chemical detection sensors 76, 78, and 80 are typically metal oxide sensors. The metal oxide is generally tin dioxide (SnO₂) although sensors based on zinc dioxide (ZnO₂), titanium dioxide (TiO₂), various forms of chromium titanate (CrₓTi_{y}O_{z}), or tungsten trioxide (WO₃) may also be used. Some metal oxide gas sensors are “off-the-shelf” and some may require special ordering from a sensor manufacturer such as Figaro Engineering, Inc.

Preferably the chemical detection sensors 76, 78 and 80 are continuously biased with a fixed voltage when the chemical detection system 10 is in use, so that no warm-up time is required. The electronic signal indicative of the concentration level of chemical detected by each of the chemical detection sensors 76, 78, and 80 is typically provided to the electronics module 32 through an electronic output/input connector 84 that is interfaced with the electronic input/output connector 34 in the chemical detector bay 26. The interface between the output/input connector 84 and the electronic input/output connector 34 provides, at least in part, operable communication between the electronics module 32 and the chemical detector sensor cartridge 70. The electronics module 32 is typically configured with an electronic calendar and clock, and the electronics module 32 typically establishes a detection reference time that is the date and time when a chemical concentration level is provided by the chemical detection sensors 76, 78, and 80 to the electronics module 32

In many embodiments the chemical detection sensors 76, 78, and 80 are plug-in modules that may be interchanged in order to vary the types of chemicals that are detected by the chemical detection system 10. In such configurations the chemical detector sensor cartridge 70 and the electronics module 32 typically use the electronic output/input connector 84 and the electronic input/output connector 34 to provide to the electronics module 10 the identity of the specific chemical detection sensors 76, 78, and 80 that are installed in the chemical detector sensor cartridge 70.

The electronics module 32 is typically configured to associate an alarm threshold level with each of the chemical detection sensors 76, 78, and 80 installed in the chemical detector sensor cartridge 70. Table 1 provides an exemplary list of chemical vapors for which chemical detection sensors may be installed, and the typical alarm threshold concentration level for each chemical vapor. It is understood that the threshold levels are established to indicate that the chemical is detected as present at (or above) the stated concentration level at a specific statistical confidence level, which is typically 95%.

TABLE 1

| Chemical | Alarm Threshold | |
|---|---|---|
| Propane | ≧500 | ppm |
| Methane | ≧500 | ppm |
| Typical Combustible Gas | ≧500-10,000 ppm (depending | |
| | on the gas) | |
| Gasoline and Diesel Exhaust | ≧10 | ppm |
| Ether | ≧50 | ppm |
| Ammonia | ≧10 | ppm |
| Hydrogen Sulfide | ≧5 | ppm |
| Alcohol, toluene, xylene, other | ≧50 | ppm |
| volatile organic compound vapors | | |
| Freon (R-22, R-21, R-143A, R-113) | ≧100 | ppm |

An array of chemical detection sensors (e.g., the array of chemical detection sensors 76, 78, and 80) is typically selected to detect a combination of chemicals that may indicate the presence of a particular chemical operational condition, or a chemically hazardous environment, or an illicit chemical production activity. For example, the detection of propane, ammonia, and ether in excess of the alarm threshold limits of Table 1 is a strong indication of nearby production of methamphetamines.

The electronics module 32 is configured to structure the situation indicator 36 in an alarm indication mode if the concentration level(s) detected by the chemical detection sensors 76, 78, and/or 80 exceed an alarm condition. For example, in some embodiments the electronics module 32 may be configured to structure the situation indicator 36 in a manner that provides an alarm indication when any chemical concentration detected by any chemical detection sensor (e.g., chemical detection sensor 76, 78 or 80) exceeds its alarm threshold. In some embodiments the electronics module 32 may be configured to structure the situation indicator 36 in a manner that provides an alarm indication when the chemical concentration detected by a plurality of the chemical detection sensors exceeds their alarm thresholds, and in some embodiments the electronics module 32 may be configured to structure the situation indicator 36 in a manner that provides an alarm indication when the chemical concentration detected by all of the chemical detection sensors installed in the chemical detector sensor cartridge 70 exceeds their alarm thresholds. The alarm indication provided by the situation indicator 36 may be, for example, a visual indication, an audible indication, or a mechanical indication such as a vibration. The combination of the electronics module 32 and the situation indicator 36 is an example of an evaluation system that is configured to associate an alarm threshold level with each of the plurality of chemical detection sensors (e.g., the chemical detection sensors 76, 78, and 80) and that is configured to provide an alarm indication.

Some embodiments of the chemical detector sensor cartridge 70 may include a sample collection chamber 86. The sample collection chamber 86 is configured so that a portion of the ambient fluid that flows into the detection chamber 82 through the fluid entry coupler 72 flows into the sample collection chamber 86. The sample collection chamber 86 includes a sample collection device 88. The sample collection device 88 is typically a standard charcoal tube for a gas chromatograph. The sample collection device is configured to retain a sample of chemicals entrained in the ambient fluid processed through the chemical detector sensor cartridge 70. The collection chamber is typically configured so that the sample collection device 88 may be installed and removed from the sample collection chamber 86 through an access port 90 so that any chemicals trapped in the sample collection device 88 may be analyzed in a laboratory. In some embodiments the sample collection device 88 bears an identification code 92 that is readable by an electronic reader 94. For example the identification code 92 may be a barcode or a radio frequency identification (RFID) tag and the corresponding electronic reader 94 is then a barcode reader or an RFID reader. In such configurations the electronic reader 94 is in operable communication with the electronics module 32, and the electronics module is configured to electronically record the identity of the sample collection device 88.

In addition to electronically recording the identity of the sample collection device 88, the electronics module 32 is typically configured to associate that identity information with relevant collection information, such as the date and time of sample collection, the concentration levels detected, the detection reference time, and a visual image 50 captured at the time of sample collection together with the image reference time 52. The numerical data and images available in the electronics module 32 are typically either transmitted electronically to a remote location or recorded on the previously-described information storage medium 40.

It is to be appreciated that while the embodiment of FIGS. 1 and 3 depict a chemical detector sensor cartridge 70 that is detachable from the chemical detection system 10, in alternate embodiments the chemical detection sensors 76, 78, and 78 and/or the sample collection chamber 86 may be fixedly installed in the chemical detection system 10.

In some applications a person using the chemical detection system 10 may be exposed to dangerous levels of chemical vapors while investigating the chemical concentration levels within an ambient environment. For example a law enforcement officer may detect the likely presence of methamphetamine production by using the chemical detection system 10 to sniff around a door. However, the law enforcement officer may be unaware that by opening the door the officer would be exposed to hazardous amounts of ammonia. To provide a warning of such possibility, in some embodiments of the chemical detection system 10, the electronics module 32 may be configured to associate a dangerous threshold level with at least one of the chemical detection sensors 76, 78, and 80 installed in the chemical detector sensor cartridge 70. Specific dangerous threshold levels are typically established by various safety organizations, such as Permissible Exposure Limits (PELs) established by the U.S. Occupational Safety and Health Administration (OSHA) and the Threshold Limit Values—Short-term Exposure Limit (TLVs-STEL) and Threshold Limit Values—Time-weighted Average (TLVs-TWA) limits established by the American Conference of Government Industrial Hygienists (ACGIH). Hazardous alarm levels are typically established to indicate that the chemical is detected as present at (or above) the stated concentration level at a specific statistical confidence level, which is typically 95%.

When any of the chemical detection sensors 76, 78, or 80 detects a dangerous threshold of chemical concentration the electronics module 32 is typically configured to generate an urgent alarm signal. The urgent alarm signal may be a special audible warning indication or a special visual indication or a special mechanical indication. In some embodiments the chemical detection system 10 may associate alarm levels with both an alarm threshold level and a dangerous threshold level, and in some embodiments the chemical detection system 10 may associate alarm levels with more than two threshold levels.

Typically, to operate the chemical detection system 10, the user points the detection port 16 in the direction where the ambient environment is to be sampled. Optionally, if so-configured, the tube 20 may be extended to access a region of the ambient environment distal to the stock 22 of the chemical detection system 10. The operator then pulls the trigger 18. The aspirator 14 draws in a sample of ambient fluid from the environment through a detection port 16, and at least a portion of the ambient fluid that is drawn in is conveyed to the detection chamber 82 of the chemical detector sensor cartridge 70. The chemical detection sensors 76, 78 and 80 provide a concentration level of chemicals detected to the electronics module 32. If the chemical detection system 10 is equipped with an information storage system 40, the electronics module 32 may record the concentration level along with the date and time of detection (i.e., the detection reference time) in the information storage system 40. The electronics module 32 also typically compares the concentration levels of chemical vapors detected by the chemical detection sensors 76, 78, and 80 with the corresponding alarm thresholds and then structures the situation indicator 36 to alert the operator if an alarm indication occurs.

In embodiments that include the sample collection chamber 86, the chemical detection system 10 may retain a sample of chemicals entrained in the ambient fluid processed through the chemical detection module 70 in the sample collection device 88. In some embodiments the chemical detection system includes the electronic reader 94, the sample collection device includes the identification code 92, and the electronics module may acquire the identification of the sample collection device 88 from the identification code 92 and record the identification data along with the detection reference time in the information storage system 40.

FIGS. 4 and 5 illustrate a top view and an elevation view (respectively) of an embodiment of a chemical detection system 110 that is similar to the chemical detection system 10 of FIG. 1. However, as seen in FIG. 5, the chemical detection system 110 includes a pistol-style grip 112 with a trigger 114 adjacent the pistol-style grip 112. The chemical detection system 110 also has a battery 116 that is different in configuration than the battery 12 of the chemical detection system 10 of FIG. 1.

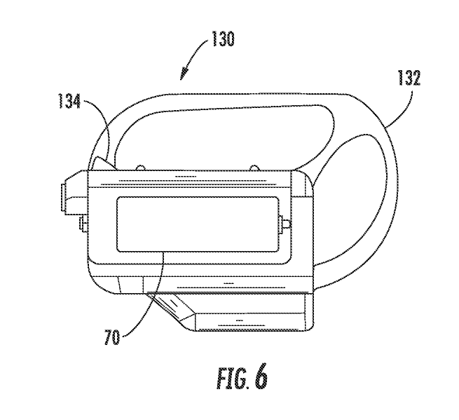

FIG. 6 presents an elevation view of an alternate embodiment of a chemical detection system 130. The chemical detection system 130 includes a grip handle system 132 and the chemical detection system 130 has a situation indicator 134 that is mounted in a forward portion of the chemical detection system 130.

In summary, embodiments are disclosed herein for various chemical detection systems. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

1. A chemical detection system comprising:
a plurality of chemical detection sensors wherein each sensor is detects a concentration level of a different chemical;
an ambient fluid sampling system that provides at least a portion of a processed ambient fluid to the plurality of chemical detection sensors; and
an evaluation system that associates an alarm threshold level with each of the plurality of chemical detection sensors wherein the evaluation system provides alarm indications for each of the plurality of chemical detection sensors if the concentration level of the chemical detected by each of the plurality of the chemical detection sensors in the at least a portion of the processed ambient fluid exceeds the alarm threshold level of that chemical detection sensor and wherein the alarm indications indicate the presence of a particular chemical operational condition, or a chemically hazardous environment, or an illicit chemical production activity.

2. The chemical detection system of claim 1 further comprising;
a visual imaging device that produces an electronic visual image of a scene associated with a location of the chemical detection system at an image reference time; and
an information storage system that records the electronic visual image of the scene associated with the location of the chemical detection system at the image reference time and that records the concentration levels of the chemicals detected by the plurality of chemical detection sensors approximately at the image reference time.

3. (canceled)

4. The chemical detection system of claim 1 wherein the evaluation system associates a threshold exposure level that is dangerous to a human with at least one of the plurality of chemical detection sensors and that provides an urgent alarm signal if the detected chemical concentration level of the at least one of the chemical detection sensors exceeds the threshold exposure level.

5. (canceled)

6. (canceled)

7. The chemical detection system of claim 1 further comprising a sample collection chamber and a sample collection device separate from the sample collection chamber wherein the sample collection device retains a sample of chemicals from the processed ambient fluid.

8. (canceled)

9. (canceled)

10. The chemical detection system of claim 1 wherein:
the evaluation system that associates a threshold exposure level that is dangerous to a human with at least one of the plurality of chemical detection sensors and that provides an urgent alarm signal if the detected chemical concentration level of the at least one of the plurality of chemical detection sensors exceeds the threshold exposure level.

11. (canceled)

12. A chemical detection system comprising:
a chemical detection sensor that detects a concentration level of a chemical;
an ambient fluid sampling system that provides at least a portion of a processed ambient fluid to the chemical detection sensor; and
an evaluation system that associates an alarm threshold level with the chemical detection sensor and that associates a threshold exposure level that is dangerous to a human with the chemical detection sensor and that provides an alarm signal if the concentration level of the chemical detected by the chemical detection sensor in the at least a portion of the processed ambient fluid exceeds the alarm threshold level of the chemical detection sensor and that provides an urgent alarm signal if the concentration level of the chemical detected exceeds the threshold exposure level of the chemical detection sensor.

13. The chemical detection system of claim 12 further comprising;
a visual imaging device that produces an electronic visual image of a scene associated with a location of the chemical detection system at an image reference time; and
an information storage system that records the electronic visual image of the scene associated with the location of the chemical detection system at the image reference time and that records the concentration levels of the chemicals detected by the plurality of chemical detection sensors approximately at the image reference time.

14. (canceled)

15. The chemical detection system of claim 12 further comprising a sample collection chamber and a sample collection device separate from the sample collection chamber wherein the sample collection device retains a sample of chemicals from the processed ambient fluid.

16. (canceled)

17. (canceled)

18. A chemical detection system comprising:
a sample collection chamber;
a chemical detection sensor that detects a concentration level of a chemical;
an ambient fluid sampling system that provides at least a portion of a processed ambient fluid in the sample collection chamber to the chemical detection sensor;
an evaluation system that associates an alarm threshold level with the chemical detection sensor and that provides an alarm signal if the concentration level of the chemical detected by the chemical detection sensor exceeds the alarm threshold level of the chemical detection sensor; and
a sample collection device separate from the sample collection chamber wherein the sample collection device retains a sample of chemicals from the processed ambient fluid.

19. The chemical detection system of claim 18 further comprising:
a visual imaging device that produces an electronic image of a scene associated with a location of the chemical detection sensor at an image reference time; and
an information storage system that records the electronic image of the scene associated with the location of the chemical detection sensor at the image reference time and that records the concentration level of the chemical detected by the chemical detection sensor approximately at the image reference time.

20. The chemical detection system of claim 18 wherein the sample collection device is associated with an installed device identification number and wherein the chemical detection system further comprises an information storage system that records the concentration level of the chemical detected by the chemical detection sensor at a detection reference time and that records the device identification number of the sample collection device at the detection reference time.

21. The chemical detection system of claim 1 wherein the alarm indications indicate the presence of a particular chemical operational condition.

22. The chemical detection system of claim 1 wherein the alarm indications indicate a chemically hazardous environment.

23. The chemical detection system of claim 1 wherein the alarm indications indicate an illicit chemical production activity.

24. The chemical detection system of claim 7 wherein the sample collection device is associated with an installed device identification number and wherein the chemical detection system further comprises an information storage system that records the concentration level of the chemical detected by the chemical detection sensor at a detection reference time and that records the device identification number of the sample collection device at the detection reference time.

25. The chemical detection system of claim 7 wherein the sample collection device comprises a charcoal tube for a gas chromatograph.

26. The chemical detection system of claim 15 wherein the sample collection device is associated with an installed device identification number and wherein the chemical detection system further comprises an information storage system that records the concentration level of the chemical detected by the chemical detection sensor at a detection reference time and that records the device identification number of the sample collection device at the detection reference time.

27. The chemical detection system of claim 15 wherein the sample collection device comprises a charcoal tube for a gas chromatograph.

28. The chemical detection system of claim 18 wherein the sample collection device comprises a charcoal tube for a gas chromatograph.

29. The chemical detection system of claim 1 further comprising a sample collection chamber and a sample collection device separate and removable from the sample collection chamber wherein the sample collection device retains a sample of chemicals from the processed ambient fluid.
